(19) United States
(12) Patent Application Publication
(10) Pub. No.: US 2005/0015403 A1
(43) Pub. Date: Jan. 20, 2005

(54) TWAIN network image transmission system and method

(76) Inventor: Hung-Yi Wu, Taipei (TW)

Correspondence Address: RABIN & CHAMPAGNE, P.C., 1101 14 Street, N.W., Suite 500, Washington, DC, 20005, US

(21) Appl. No.: 10/618,677

(22) Filed: Jul. 15, 2003

(51) Int. Cl. G06F 7/00

(52) U.S. Cl. 707/104.1

(57) ABSTRACT

A TWAIN network image data transmission system and method are applicable in image data transmission between a host and a versatile business machine. The TWAIN network image data transmission is achieved via a network using HTTP. After the versatile business machine retrieves the image data, an image data hyperlink embedded hypertext is generated. When an image data retrieving command is sent from the host, the hypertext is transmitted to the host via the network and a communication interface with hypertext transport protocol.

### BACKGROUND OF THE INVENTION

1. Field of Invention

The present invention relates to a network image transmission system and a network image transmission method, and more particularly to a TWAIN network image transmission system and a TWAIN network image transmission method.

2. Related Art

A TWAIN (tool without an interesting name) standard is a standard of protocol for linking applications and image output devices. Any peripherals compatible with the TWAIN protocol standard, such as a scanner or a digital camera, are controlled via a software that is able to support the TWAIN driver. Before the TWAIN protocol standard was developed, the user had to scan through a specific application for the scanner, for example, and then edit the scanned image after the image was saved. The TWAIN protocol standard simplifies the scan processing by enhancing the compatibility of the image-handling software and hardware.

The image is retrieved through the scanner, digital camera or other image acquisition software, and transmitted to the corresponding application. TWAIN includes an application supporting the TWAIN protocol, a TWAIN source manager and an information source (image acquisition device). The information source is a hardware interface. If the information source enables remote connection via network, then it must involve two parts: one is an application execution at a local machine site, and the other is an application execution at a remote resource device site. Through a network TWAIN protocol, the local information source transmits an operation command from the applications and the source manager to a form understandable by the remote information device. Through a non-network TWAIN protocol, the image transmission is achieved via a parallel port or a universal serial bus (USB). Commercially available versatile business machines scanners, or digital cameras impress the network function in addition to their classic functions. Therefore the image transmission also relies on the network. Most files are transmitted to a TCP/IP form or other format. The transmission of image files via the TWAIN network is not limited to the above ways. In the future, the versatile business machine may become a document management center in which easy finding and managing of the document should be allowed. Therefore, there is a need for an effective image transmission system via the TWAIN network.

### SUMMARY OF THE INVENTION

It is therefore an object of the invention to provide a TWAIN network image transmission system which achieves the TWAIN network image transmission of the versatile business machine via a hypertext transport protocol (HTTP).

In order to achieve the above and other objectives, the TWAIN network image transmission system of the invention includes a versatile business machine site for providing image sources, a host site for receiving images, and a network. The network links the host site and the versatile business machine site, and uses the versatile business machine site as a server site. The versatile business machine site includes an image acquisition module, a data storage module, a server site TWAIN information management program and a first communication interface with a hyper-document program protocol. The image acquisition module retrieves the image data. The data storage module stores the image data and obtains an image data hyperlink address to generate an image data hyperlink embedded hyper-document. The TWAIN data management program at the server site receives image data retrieving command, and transmits the image data hyperlink embedded hyper-document to the host site via the communication interface with a hyper-document transmission protocol. At the host site are included a user-site TWAIN data management program and a second communication interface with hyper-document transmission protocol. The user-site TWAIN data management program sends image data retrieving command and transmits the image data to the server-site TWAIN data management program, in order to receive and display the image data hyperlink embedded hyper-document and retrieve the image data.

With the above system, the process of transmitting the image data from the versatile business machine to the host site via the TWAIN network includes: the versatile business machine picking up the image data, saving the image data and obtaining an image data hyperlink address. The versatile business machine generates image data hyperlink hyper-document. An image data retrieving command comes from the host site. The image data hyperlink embedded hyper-document is transmitted to the host site after the versatile business machine receives the image data retrieving command from the host site. The host displays the image data hyperlink embedded hyper-document and recognizes its hypertext markup language to retrieve the image data.

The user-site TWAIN data management program of the host plays a communication role for users. With the user-site data management program, operation command can be sent to receive the hyper-document. A data management program with browsing function may be used as the user-site TWAIN data management program. The versatile business machine is responsible for executing the commands from the user-site TWAIN data management program and feedback to a front end application to display the operation result.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent from this detailed description to those skilled in the art.

### BRIEF DESCRIPTION OF THE DRAWINGS

The present invention will become more fully understood from the detailed description given herein below illustration only, and is thus doesn't limit the present invention:

FIG. 1 is a schematic view of a TWAIN network image transmission system according to one embodiment of the invention; and

FIG. 2 is a schematic view of a TWAIN network image transmission method according to another embodiment of the invention.

### DETAILED DESCRIPTION OF THE INVENTION

According to the invention, data transmission between a host site and a versatile business machine via a TWAIN network is realized through a hypertext transport protocol (HTTP). Considering that MFP may become a file manage center in which a browser may be used for file searching, TWAIN network image transmission through HTTP is similar to file downloading through the browser.

HTTP is a rule of data exchange through a world wide web (WWW), which is widely used to define the interaction between a homepage and a server. Compared with the TCP/IP protocol, HTTP is an application protocol. One of the key features of HTTP is that it is a cross-platform through which data saved in different computer systems are linked on the Internet. A hypertext markup language (HTML) is used to define the content and type of a HTTP hyper-document. This type of encoding format also defines page edition and image data embedded hyperlinks. According to the invention, the size, compression rate and location of the image data can be changed to properly embed the image data into the page by setting the HTML parameters. Furthermore, while clicking the hyperlink address of the image data the user retrieves a primary file including the image data.

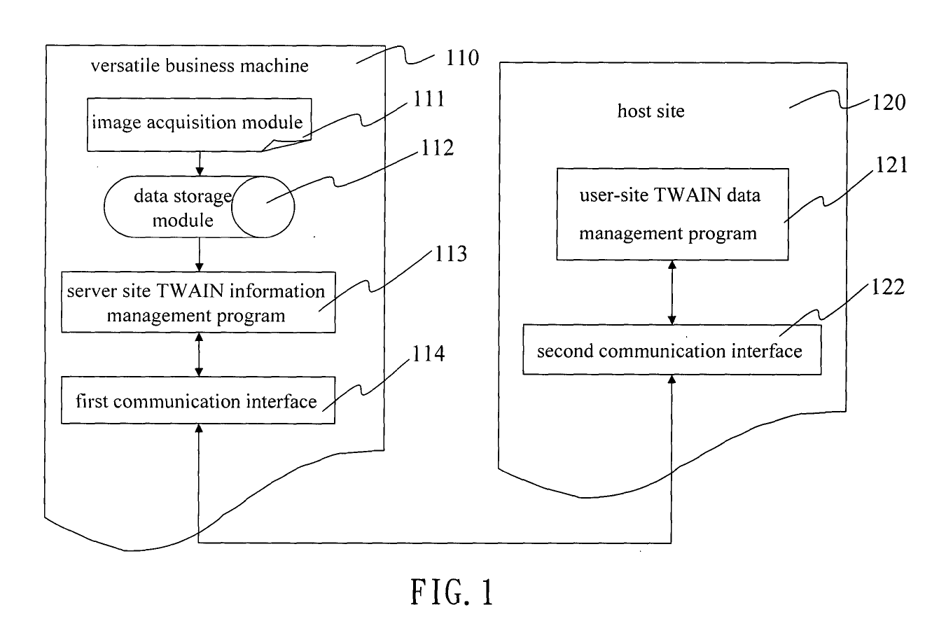

FIG. 1 is a schematic view of a TWAIN network image transmission system according to one embodiment of the invention. The TWAIN network image transmission system includes a versatile business machine site for providing image sources, a host site for receiving images and a network. The network links the host site and the versatile business machine site.

As illustrated, a versatile business machine 110 includes an image acquisition module 111, a data storage module 112, a server site TWAIN information management program 113 and a first communication interface 114 with hyper-document transmission protocol. The image acquisition module 111 retrieves the image data. The data storage module 112 stores the image data and obtains an image data hyperlink address to generate an image data hyperlink embedded hyper-document. After the TWAIN data management program 113 receives an image data retrieving command from the host site 120, the image data hyperlink embedded hyper-document is transmitted to the host site 120 via the communication interface with a hyper-document transmission protocol. At the host site 120 are included a user-site TWAIN data management program 121 and a £122 with a hyper-document transmission protocol. The user-site TWAIN data management program 121 sends an image data retrieving command to a versatile business machine site TWAIN data management program 113 and receives and displays the image data hyperlink embedded hyper-document via the second communication interface 122 to retrieve the image data. Since the TWAIN network data transmission is achieved through HTTP, the server-site TWAIN data management program is provided with a browsing function, which is convenient to read and download the image data. The image acquisition module retrieves the image data by scanning.

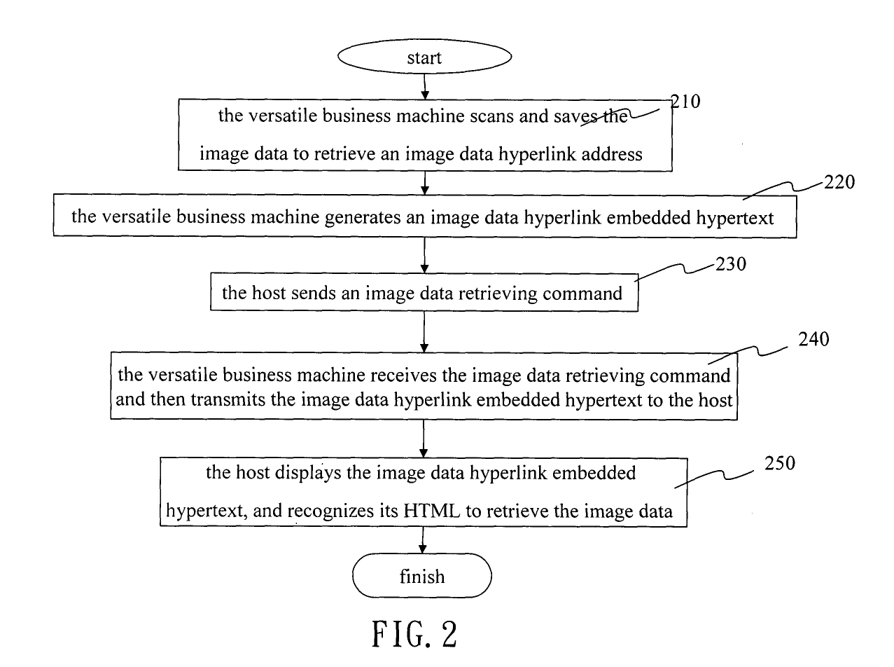

FIG. 2 is a flow chart of the operation of a TWAIN network image transmission, using HTTP, between a host and a versatile business machine via a communication interface with a hyper-document transport protocol. Referring to FIG. 2, the versatile business machine scans and saves the image data to retrieve an image data hyperlink address (step 210). The versatile business machine generates image data hyperlink embedded hyper-document (step 220). The host sends an image data retrieving command (step 230). The versatile business machine receives the image data retrieving command and then transmits the image data hyperlink embedded hyper-document to the host (step 240). The host displays the image data hyperlink embedded hyper-document, and recognizes its HTML to retrieve the image data (step 250). The hyper-document is a text file without any image or other forms. When the image data hyperlink embedded hyper-document is recognized, if it is found that image display is required in the hyper-document, then a request of download image data is sent.

Before the versatile business machine generates the image data hyperlink embedded hyper-document, setting HTML parameters is performed. Setting the HTML can change the size, compression rate and location of the image of the hypertext displayed at the host site for properly embedding into the display page. For those who use massive image transmission, more time is saved by using the TWAIN network.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A TWAIN network image transmission system, comprising:
a versatile business machine as a server site, including:
an image acquisition module, used to retrieve image data;
a data storage module, storing the image data and obtaining an image data hyperlink address to generate an image data hyperlink embedded hypertext;
a server site TWAIN information management program, receiving an image data retrieving command to transmit the image data hyperlink embedded hypertext; and
a first communication interface with hypertext transmission protocol, transmitting the image data hyperlink embedded document;
a host, receiving the image data, the host including:
a user-site TWAIN data management program, sending the image data retrieving command to the server-site TWAIN data management program, and receiving and displaying the image data hyperlink hypertext;
a second communication interface with hypertext transport protocol, transmitting the image data hyperlink embedded hypertext to the user-site TWAIN data management program;
and
a network, linking the first communication interface of the versatile business machine to the second communication interface of the host.

2. The system of claim 1, wherein the image acquisition module retrieves the image data by scanning.

3. The system of claim 1, wherein the user-site TWAIN data management program is a data management program with browsing function.

4. A TWAIN network image transmission method using HTTP and a communication interface with hypertext transport protocol to provide data transmission between a host and a versatile business machine, the steps comprising:
the versatile business machine scanning and saving the image data to retrieve an image data hyperlink address;
the versatile business machine generates an image data hyperlink embedded hypertext;
the host sending an image data retrieving command;
the versatile business machine receiving the image data retrieving command and then transmitting the image data hyperlink embedded hypertext to the host; and
the host displaying the image data hyperlink embedded hypertext, and recognizing its HTML to retrieve the image data.

5. The method of claim 4, wherein the versatile business machine retrieves the image data by scanning.

6. The method of claim 4, wherein the user-site TWAIN data management program is a data management program with browsing function.

7. The method of claim 4, further comprising setting HTML parameters before the versatile business machine generates the image data hyperlink embedded hypertext.
